(19) United States
(12) Patent Application Publication
(10) Pub. No.: US 2024/0231208 A9
(43) Pub. Date: Jul. 11, 2024

(54) Mixed Illumination Projector for Display System

(71) Applicant: DigiLens Inc., Sunnyvale, CA (US)

(72) Inventors: Nima Shams, Sunnyvale, CA (US); John Border, Sunnyvale, CA (US); Nicholas Sherwood, Sunnyvale, CA (US)

(73) Assignee: DigiLens Inc., Sunnyvale, CA (US)

(21) Appl. No.: 18/491,247

(22) Filed: Oct. 20, 2023

Related U.S. Application Data
(60) Provisional application No. 63/380,283, filed on Oct. 20, 2022.

(51) Int. Cl. G03B 21/20

(52) U.S. Cl. CPC G03B 21/2033; G03B 21/2013; G03B 21/2066

(57) ABSTRACT

Disclosed herein is a mixed illumination system including: a first light source; a second light source of different type than the first light source, where the wavelength an output of the second light source does not overlap with the wavelength of an output of the first light source; and a combiner which is configured to combine the output of the first light source and the second light source. The light from the first light source and the second light source are combined within the combiner into a combined beam.

### CROSS-REFERENCED APPLICATIONS

This application claims priority to U.S. Provisional Application 63/380,283 filed on Oct. 20, 2022, the disclosure of which is incorporated by reference in its entirety.

### FIELD OF THE INVENTION

The present invention generally relates to illuminators for projectors for display systems that include mixed illumination types.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within or on the surface of the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal (LC) micro-droplets, interspersed with regions of clear polymer. The alternating liquid crystal-rich and liquid crystal-depleted regions form the fringe planes of the grating.

Waveguide optics, such as those described above, can be considered for a range of display systems and sensor applications. In many applications, waveguides containing one or more grating layers encoding multiple optical functions can be realized using various waveguide architectures and material systems, enabling new innovations in near-eye displays for Augmented Reality (AR) and Virtual Reality (VR), compact Heads Up Displays (HUDs) for aviation and road transport, and sensors for biometric and laser radar (LIDAR) applications. As many of these applications are directed at consumer products, there is a growing requirement for efficient low cost means for manufacturing holographic waveguides in large volumes.

In near-eye displays and display devices it may be beneficial that the overall system includes a waveguide and a projector including an illumination system having high brightness.

### SUMMARY OF THE INVENTION

In some aspects, the techniques described herein relate to a mixed illumination system for a projector including: a first light source; a second light source of different type than the first light source, wherein the wavelength of an output from the second light source does not overlap with the wavelength of an output of the first light source; and a combiner which is configured to combine the output of the first light source and the second light source, wherein light from the first light source and the second light source are combined within the combiner into a combined beam.

In some aspects, the techniques described herein relate to an illumination system, wherein the first light source is a laser light source and the second light source is an LED light source, wherein the output of the laser light source has a higher speckling than the combined beam.

In some aspects, the techniques described herein relate to an illumination system, further including a holographic diffuser.

In some aspects, the techniques described herein relate to an illumination system, wherein the combined beam has a larger angular emission than the output from the first light source or the second light source.

In some aspects, the techniques described herein relate to an illumination system, further including an angled mirror, wherein a center spot of the mirror is substantially transmissive and the surrounding area of the mirror is substantially reflective.

In some aspects, the techniques described herein relate to an illumination system, further including a third light source with an overlapping wavelength with the laser light source, wherein the third light source is an LED light source, wherein the output from the laser light source is transmitted through the center spot and the output from the third light source is reflected by the angled reflective mirror such that the transmitted laser light and the reflected light from the third light source share a common optical axis.

In some aspects, the techniques described herein relate to an illumination system, wherein the combiner is an angled mirror with a dichroic coating associated with the second light source which reflects light from the second light source and transmits light from the first light source and the third light source to transmit a combined light of the first light source, the second light source, and the third light source to provide a combined light with a common optical axis.

In some aspects, the techniques described herein relate to an illumination system, further including a fourth light source and a second angled mirror with a dichroic coating associated with the fourth light source which reflects light from the fourth light source and transmits light form the first light source, the second light source, and the third light source to provide a combined light with a common optical axis.

In some aspects, the techniques described herein relate to an illumination system, further including an uniformizer positioned along the common optical axis.

In some aspects, the techniques described herein relate to an illumination system, wherein the uniformizer includes a holographic flattop diffuser or a fly's eye array.

In some aspects, the techniques described herein relate to an illumination system, wherein the first light source and the third light source output green light.

In some aspects, the techniques described herein relate to an illumination system, wherein the first light source is a green LED light source and the third light source is a green laser light source.

In some aspects, the techniques described herein relate to an illumination system, further including an angled mirror, wherein a center spot of the mirror is substantially reflective and the surrounding area of the mirror is substantially transmissive.

In some aspects, the techniques described herein relate to an illumination system, further including a third light source with an overlapping wavelength with the laser light source, wherein the third light source is an LED light source, wherein the output from the laser light source is transmitted through the center spot and the output from the third light source is reflected by the angled reflective mirror such that the transmitted laser light and the reflected light from the third light source share a common optical axis.

In some aspects, the techniques described herein relate to an illumination system, wherein the combiner is an angled mirror with a dichroic coating associated with the second light source which reflects light from the second light source and transmits light from the first light source and the third light source to transmit a combined light of the first light source, the second light source, and the third light source to provide a combined light with a common optical axis.

In some aspects, the techniques described herein relate to an illumination system, further including a fourth light source and a second angled mirror with a dichroic coating associated with the fourth light source which reflects light from the fourth light source and transmits light form the first light source, the second light source, and the third light source to provide a combined light with a common optical axis.

In some aspects, the techniques described herein relate to an illumination system, further including a uniformizer positioned along the common optical axis.

In some aspects, the techniques described herein relate to an illumination system, wherein the uniformizer includes a holographic flattop diffuser or a fly's eye array.

In some aspects, the techniques described herein relate to an illumination system, further including an angled mirror, wherein the mirror is a notch mirror with a narrow band of reflectivity and the output from the laser light source has an emission band falling within the narrow band of reflectivity.

In some aspects, the techniques described herein relate to an illumination system, wherein the output from the laser light source is reflected by the angled mirror and the output from the LED light source has an emission band substantially wider than the narrow band of reflectivity such that the laser light is reflected by the mirror and a majority of the LED light is transmitted through the mirror, and wherein the reflected laser light and the transmitted LED light share a common optical axis.

In some aspects, the techniques described herein relate to an illumination system, further including a mirror, wherein the mirror is a notch mirror with a narrow band of transmission and the emission band of the laser falls within the narrow band of transmission.

In some aspects, the techniques described herein relate to an illumination system, wherein the laser light is transmitted and the LED light has an emission band substantially wider than the narrow band of transmission such that the laser light is transmitted through the mirror and a majority of the LED light is reflected by the mirror, and wherein the transmitted laser light and the reflected LED light share a common optical axis.

In some aspects, the techniques described herein relate to an illumination system, wherein the combined beam has improved brightness over the output of the first light source or the second light source alone.

In some aspects, the techniques described herein relate to an illumination system, wherein the combined beam has improved stability over the output of the first light source or the second light source alone.

In some aspects, the techniques described herein relate to an illumination system, wherein the combined beam has improved power efficiency over the output of the first light source or the second light source alone.

In some aspects, the techniques described herein relate to an illumination system, wherein the combined beam has improved heat output over the output of the first light source or the second light source alone.

In some aspects, the techniques described herein relate to an illumination system, wherein the combined beam has reduced speckle.

In some aspects, the techniques described herein relate to an illumination system, further including a second combiner which receives light from a third light source and the first light source and outputs light to the combiner.

In some aspects, the techniques described herein relate to an illumination system, wherein the second combiner includes a diffuser, a turning film, or a prism film.

In some aspects, the techniques described herein relate to an illumination system, wherein the combiner further receives light from a fourth light source and combines the light from the fourth light source with the light from the third light source, the second light source, and the first light source.

In some aspects, the techniques described herein relate to an illumination system, wherein the combiner includes an x-cube.

In some aspects, the techniques described herein relate to an illumination system, wherein the first light source and the third light source output red light, the second light source outputs green light, and the fourth light source outputs blue light.

In some aspects, the techniques described herein relate to an illumination system, wherein the output from the combiner is white light.

In some aspects, the techniques described herein relate to an illumination system, wherein the first light source is a red laser light source, the second light source is a green LED light source, the third light source is a red LED light source, and the fourth light source is a blue LED light source.

### BRIEF DESCRIPTION OF THE DRAWINGS

The description will be more fully understood with reference to the following figures and data graphs, which are presented as various embodiment of the disclosure and should not be construed as a complete recitation of the scope of the disclosure, wherein:

FIG. 1 illustrates a schematic of a projector in accordance with an embodiment of the invention.

FIG. 2 is a schematic of an example illumination system.

FIG. 3 is a schematic of a mixed illumination system in accordance with an embodiment of the invention.

FIG. 4 is a schematic of a mixed illumination system in accordance with an embodiment of the invention.

FIGS. 5A-5C illustrate various examples of single color mixed illumination sources utilizing mirrors in accordance with various embodiments of the invention.

FIG. 5D shows an illumination system 450 with a linear layout in accordance with an embodiment of the invention.

FIG. 6 is a plot which conceptually illustrates the operation of the notch mirror coating of FIG. 5C.

FIG. 7A is an image of the output of a red LED light source after passing through a holographic diffuser.

FIG. 7B is an image of the output of a green laser light source after passing through a holographic diffuser.

FIG. 7C is an image of the output from a combined illumination source utilizing the red LED light source of FIG. 7A and the green laser light source of FIG. 7B.

FIG. 8A is an image of the output of a green LED light source.

FIG. 8B is an image of the output of a green laser light source.

FIG. 8C is an image of the combined output of the green LED light source and the green laser light source.

FIG. 9A illustrates the illumination spots in angular space produced by an example laser without a diffuser.

FIG. 9B illustrates an example illumination including a holographic diffuser.

FIG. 10A shows the illumination spots in angular space produced by an example LED with a microlens without a diffuser.

FIG. 10B illustrates the illumination spots including a holographic diffuser.

FIG. 11 shows the illumination spot in angle space produced by an LED with a microlens and a holographic diffuser.

FIG. 12 illustrates a combined illumination spot in angular space where illumination is provided by a combined light source including a laser through the holographic diffuser and an LED with microlens through the holographic diffuser.

### DETAILED DESCRIPTION

A head worn display device may include a projector device which injects light into one or more waveguides which output image light including image content into a user's eyes. It may be advantageous for the projector to be full color and have high brightness. In full color illumination systems for head worn displays with 3 or more different colored light sources, it is often difficult to achieve a desired color balance because one or more of the light sources may not have the characteristics desired to balance with the other light sources. The characteristics can include brightness, bandwidth and power efficiency. This can be the case with various light sources such as light emitting diodes (LEDs), incandescent light sources, or lasers. Where typically color illumination systems include 3 or more colored light sources all of the same type.

The invention envisions full color illumination systems with mixed light sources of different types and wavelengths to enable improved light source characteristics. Types of light sources may include LEDs, lasers, and incandescent light sources. LEDs have high efficiency, medium brightness, rapid transition from on and off, narrow bandwidth, low cost, and wider angular emission. Lasers have high brightness, rapid transition from on and off, very narrow bandwidth and very narrow angular emission. However, lasers may suffer from speckle artifacts, lower efficiency and are also more expensive. Incandescent light sources have a low cost and a wide bandwidth. However, incandescent light sources have low efficiency and a slow transition from on and off.

Various embodiments of the invention include a full color illumination with two colors provided by LEDs and one color provided by laser. The full color illumination may include separate red, green, and blue light sources. As discussed above, LEDs provide a low cost illumination system with low power usage, but the desired brightness may not be as high as a laser light source. Further, utilizing a red LED, green LED, and blue LED may not provide a good white balance, particularly after the projected light is transmitted through a waveguide which may not be as efficient in one of the colors. One of the LEDs may have a brightness that is not as bright as the other LEDs which may provide a poor balance between the different colors (e.g. white balance). For example, it has been discovered that when the light source utilizes a red LED, the red LED does not have as much brightness compared to the brightness of a green LED and a blue LED. Thus, the brightness of the green LED and blue LED may need to be turned down to match the brightness of the red LED to produce a desired color balance (e.g. white balance) of the combined illumination from the red, green and blue which ultimately decreases the combined brightness of the illumination system. The laser may output light which has a wavelength of a non-overlapping range with the light output from the LEDs.

It has been discovered that the relatively dimmest LED to produce an acceptable white balance may be replaced with a laser to boost the brightness and enable a good white balance. However, it is known that utilizing laser light sources may result in visible speckle in the illumination. It has further been discovered that keeping at least one different light source (e.g. LED and/or incandescent light source) may reduce the speckle associated with a laser light source. Thus, it may be advantageous to provide a mixed illumination system where at least one light source is a laser light source and at least one light source is a different light source (e.g. LED and/or incandescent light source). For example, the red light source may include a red laser light source. Thus, the brightness of the green LED and the blue LED may be matched while the speckling of the red laser light source may be mitigated by the green LED and the blue LED. While the brightness of a full color illumination system may be increased for an illumination system including all laser light sources, such a system may include a high amount of speckling which would make this too non-uniform for most lighting situations.

In some embodiments, the laser light source may raster across an area to create a wider area of illumination.

Some embodiments include an RGBW illumination system in which the white color is provided by an incandescent light or fluorescent light while the RGB light sources are all LEDs. This provides a fast response RGB illumination system for video imaging while the incandescent light or fluorescent light provides an overall level of brightness with a desired (e.g. warm) white balance. Some embodiments include an RGBW illumination system in which the white color is provided by an LED with a phosphor while one or more of the RGB light sources are lasers. This provides a fast response RGB illumination system for video imaging while the LED with phosphor provides an overall level of brightness which may reduce speckle. The mixed illumination systems can be used for continuous illumination or sequential illumination such as with an liquid crystal on silicon (LCOS) or digital light processing (DLP). When used with sequential illumination, LEDs and lasers may be preferable because they include fast switching speed between on and off.

In some embodiments, the mixed illumination system may include an LED with a wider bandwidth but similar color to the laser to provide the additional brightness of the laser while reducing speckle in that color by utilizing the LED. This is a mixed illumination system for a single color. In some embodiments, this mixed single color approach could be followed for more than one color in an RGB system. When a mixed illumination system for a single color is used in an RGB illumination system, the multiple light sources for the single color can be pointed into a combining optic to align the multiple light sources to a common illumination spot.

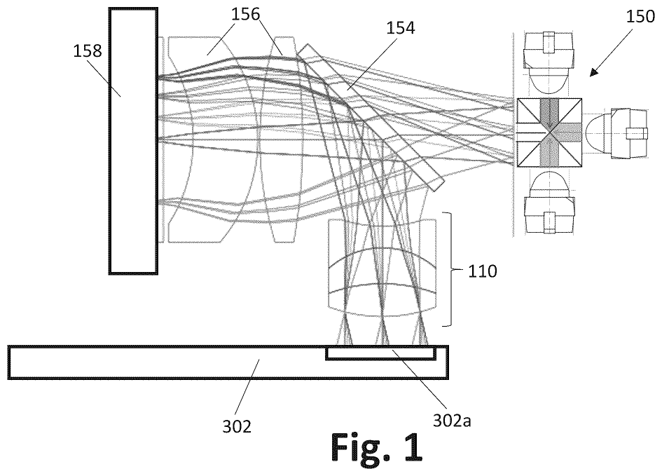

Turning now to the figures, FIG. 1 illustrates a schematic of an example projector with a reflective image source 108 such as an LCOS or a DLP and an illumination system 150 in accordance with an embodiment of the invention. The projector includes a reflective polarizer 154, where the reflective polarizer 154 is configured to transmit a first polarization light and reflect a second polarization light. The first polarization light and second polarization light may be of orthogonal polarization. The light from the illumination system 150 may include light including both the first polarization and the second polarization (also known as unpolarized light), where the first polarization light is transmitted through the reflective polarizer 154 to one or more lenses 156. For example, the reflective polarizer 154 may be configured to reflect S polarized light and transmit P polarized light. The transmitted first polarization light passes through one or more lenses 156 to illuminate a reflective image source 108 which reflects the illuminating light by converting the light, by degrees, from the first polarization to the second polarization in relation to image content. For example, the reflective image source 108 may convert the P polarized light into S polarized light which contains image data.

The one or more lenses 156 are positioned between the reflective polarizer 154 and the reflective image modulator 158. There may be one or more output lenses 110 positioned between the reflective polarizer 154 and the waveguide 302. The one or more lenses 156 first receive the light from the illumination system 150 that has been transmitted through the reflective polarizer 154 where the one or more lenses 156 focus the light to provide telecentric illuminating light with a narrow angular emission to the reflective image modulator 158. The one or more lenses 156 cooperate with the one or more output lenses 110 to form a projection lens that collimates the light from each pixel of the reflective image modulator 158 and projects the collimated light from each pixel into a unique field of view (FOV) direction. The collimated image light is directed into a waveguide 302 for observation of a projected image within a field of view by a user.

The illumination system 150 is described in more detail below in various specifically described embodiments.

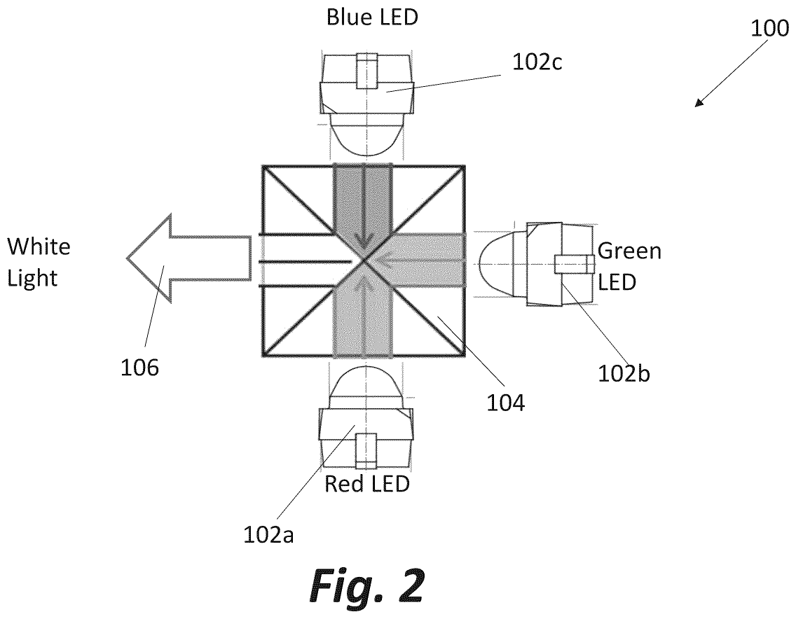

FIG. 2 is a schematic of an example illumination system. The illumination system 100 includes one or more light sources including a red LED 102a, a green LED 102b, and a blue LED 102c. The red LED 102a may output red light, the green LED 102b may output green light, and the blue LED 102c may output blue light. The red light, the green light, and the blue light are combined within a light combiner 104, where the light combiner 104 may be an x-cube. The light combiner 104 combines and aligns the red light, the green light, and the blue light and outputs combined light 106, which can be color balanced to provide a desired combined color such as white. The illumination system 100 may be utilized as a sequential RGB illumination system in a projector such as an LCOS or DLP.

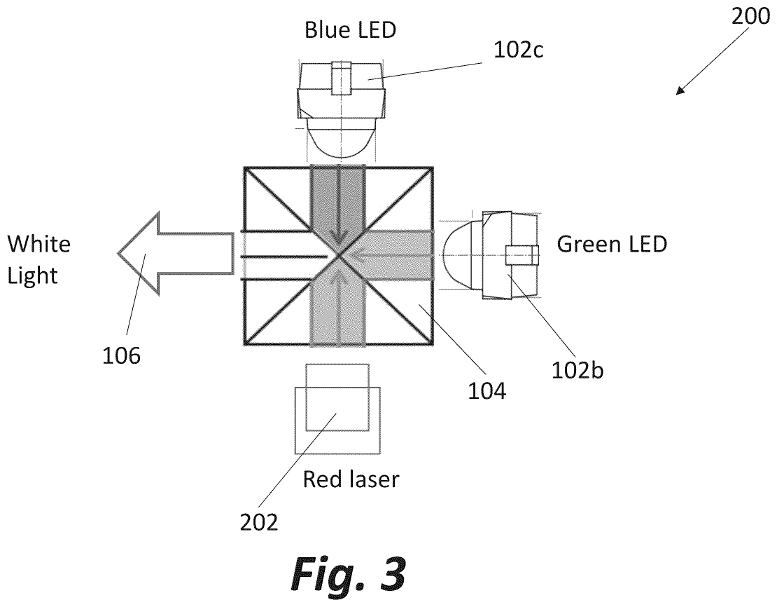

FIG. 3 is a schematic of a mixed illumination system in accordance with an embodiment of the invention. The mixed illumination system 200 includes a red laser 202, a green LED 102b, and a blue LED 102c. The red laser 202 may output red light, the green LED 102b may output green light, and the blue LED 102c may output blue light. Where the red light, the green light, and the blue light are combined and aligned within a light combiner 104 and the light combiner 104 may be an x-cube. The light combiner 104 combines and aligns the red light, the green light, and the blue light and outputs white light 106 according to the color associated with portions of the displayed image.

While a red laser 202 is illustrated, this is merely illustrative. A blue laser or a green laser may be utilized to replace the blue LED 102c or the green LED 102b. The laser may output light with a wavelength that is a non-overlapping range with the wavelength of light output by the LEDs. It has been discovered that while laser illumination creates unwanted speckle, in an illumination system 200, the speckle in the combined illumination is least noticeable when a red laser or a blue laser is used along with green and respective blue or red LEDs. Thus, red or blue lasers may be the best to use in a mixed illumination system because the speckle may be the least noticeable due to lower sensitivity in these colors by the human eye.

Mixed illumination can be provided for a single color to provide a mix of other lighting characteristics such as increased brightness with a reduced speckle or to provide a range of brightness with rapid response with a slower response base level of illumination. In this case it may be beneficial to include one or more light control films to combine the illumination from the multiple light sources. Where the light control films can include a diffuser, a holographic diffuser, a turning film or a prism film.

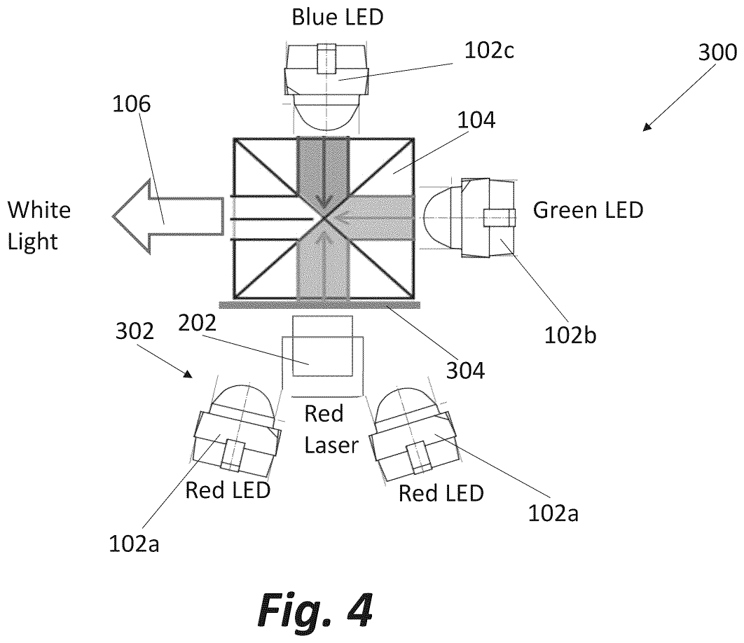

FIG. 4 is a schematic of a mixed illumination system in accordance with an embodiment of the invention. The mixed illumination system 300 includes a red mixed light source 302, a green LED 102b, and a blue LED 102c. The red mixed light source 302 includes one or more red LEDs 102a and a red laser 202. The one or more red LEDs 102a may be two or more LEDs or may be a single LED. The red mixed light source 302 may illuminate a light control film 304 which may combine the light from the one or more red LEDs 102a and the red laser 202 and output a mixed red light to a light combiner 104. The light control film 304 can include a diffuser, a holographic diffuser, a turning film or a prism film to improve the uniformity of the mixed red light. The green LED 102b may output green light and the blue LED 102c may output blue light. The red light, the green light, and the blue light are combined within a light combiner 104. The light combiner 104 may be an x-cube. The light combiner 104 combines the red light, the green light, and the blue light and outputs white light 106 according to the color associated with portions of the displayed image.

While the red mixed light source 302 is illustrated, a single-color mixed illumination system may be applied for the green light source or the blue light source. Further, different embodiments may include different systems for combining the mixed light source. It has been found, that when a single color mixed illumination system is used, the speckle from a laser in the single color mixed illumination system is reduced in the mixed light, so that green single color mixed illumination systems are effective for increasing brightness while simultaneously reducing speckle.

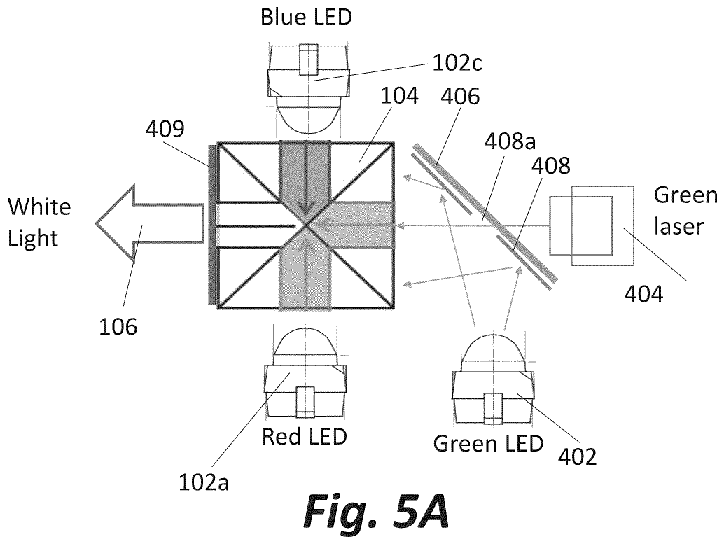

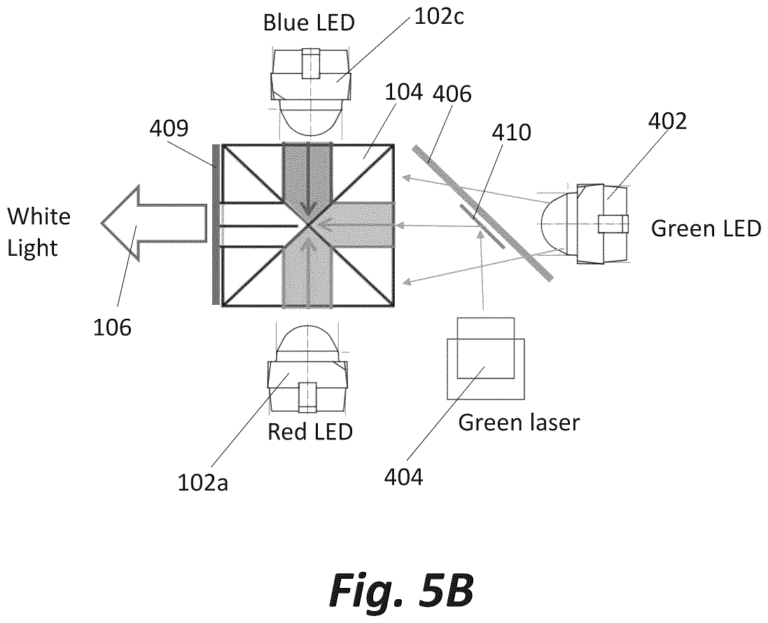

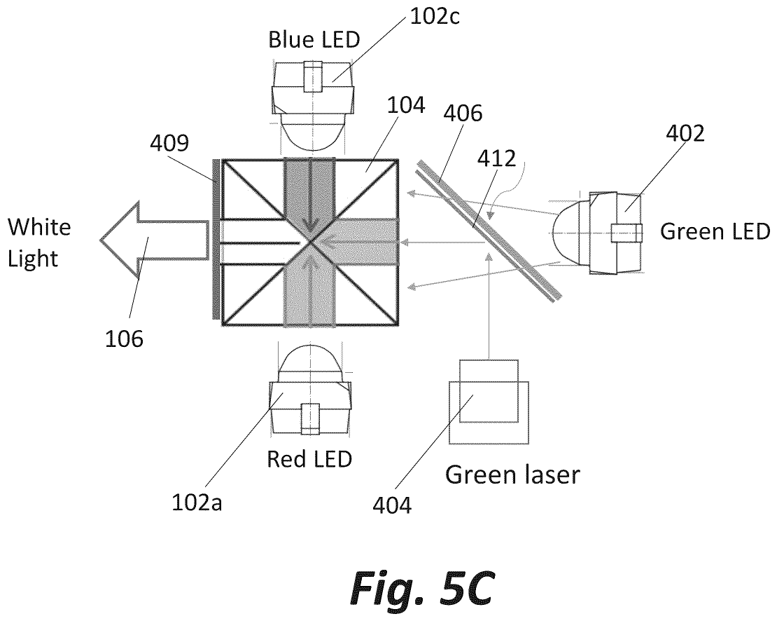

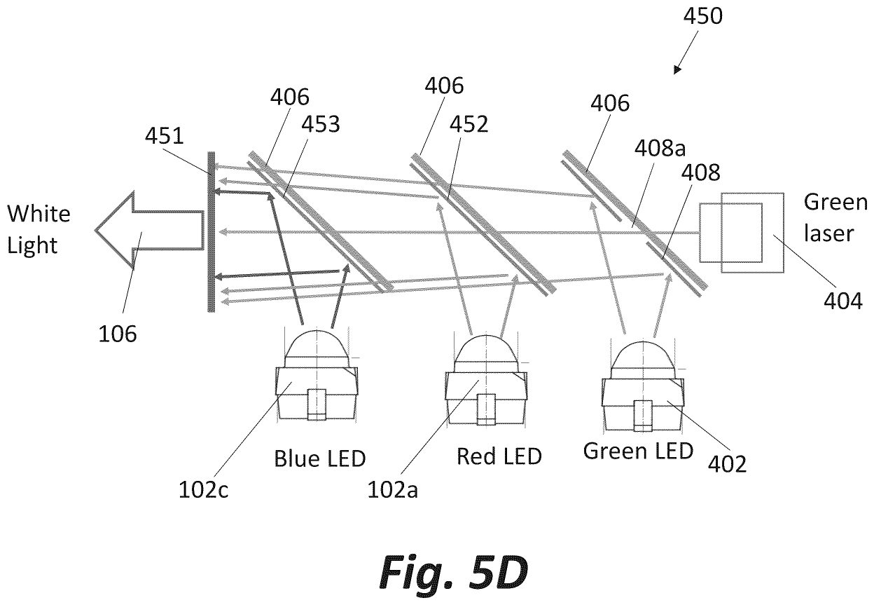

In some embodiments, one or more mirrors may be utilized to facilitate the mixing of the single color with multiple different types of light sources. FIGS. 5A-5C illustrate various examples of single color mixed illumination sources utilizing mirrors in accordance with various embodiments of the invention. These embodiments include various identically labeled elements described in the description of FIGS. 1-3 above. The description of these elements are applicable here and will not be repeated in detail.

In FIG. 5A, the green light source includes both a green LED 402 and a green laser 404. A combining system includes a substrate 406 with a simple mirror coating 408 that substantially reflects across the visible band (e.g. 450 to 670 nm). The mirror coating 408 may include a center hole 408a which may be utilized to pass through the light from the green laser 404, wherein the green laser 404 has a narrow angular emission and thus the center hole 408a may be small (e.g. 2.5 mm diameter). The center hole 408a in the mirror coating 408 allows the laser light to pass through the mirror coating 408 to the light combiner 104. The center hole 408a is transmissive whereas the surrounding area of the mirror coating 408 is reflective. This approach takes advantage of the fact that the laser 404 is more collimated than the LED 402 (e.g. a laser angular emission is typically less than +/−0.1°, whereas a typical LED even with a microlens typically has an angular emission greater than +/−10°) and as a result the laser provides a smaller spot size at the angled mirror surface as shown in FIGS. 5A, 5B and 5C. This embodiment takes advantage of the difference in angular emission between the different light sources and thereby can use a simple mirror coating with a hole to combine the different light sources along a common optical axis. The presence of the small hole in the mirror introduces a small loss for the LED light source, but the addition of the laser light source more than makes up for this loss.

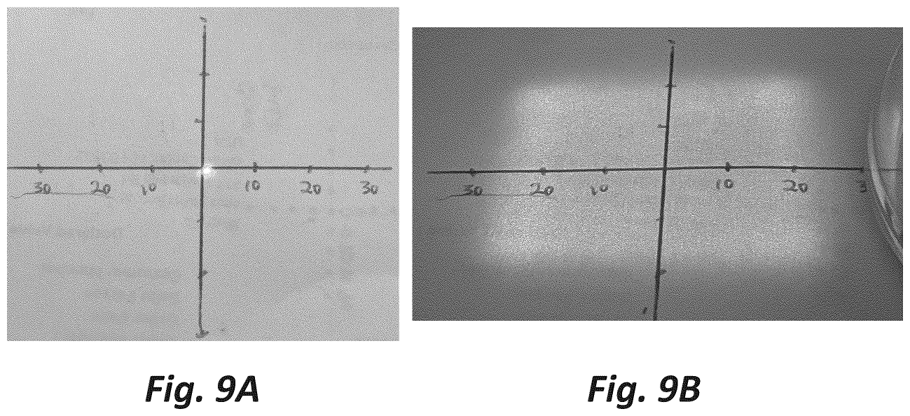

In the embodiments associated with FIGS. 5A, 5B and 5C which include an angled mirror to align the light from a laser and the light from an LED, there may be an additional holographic diffuser 409 which converts the angular emission from the two different light sources to substantially uniform areas of illumination with similar angular emissions that overlay one another to produce a brighter mixed illumination with reduced speckle. The holographic diffuser 409 may effectively spread the light from an original small spot to a substantially uniform illumination over a rectangular area and the effect of the holographic diffuser 409 is stronger on the laser than the LED so that the angular emissions produced after passing through the holographic diffuser 409 can be substantially similar for the laser and the LED. Examples of the operation of the holographic diffuser 409 are described in connection with FIGS. 9-12. As discussed below, the presence of the holographic diffuser 409 alone may not be enough to eliminate speckling.

The configuration illustrated in FIG. 5B is similar to the configuration described in connection with FIG. 5A however the position of the green laser 404 and the green LED 402 are reversed. Also, a simple mirror coating 410 that substantially reflects across the visible band (e.g. 450 to 670 nm) is coated on the substrate 406, where the mirror coating 410 only occupies a small center spot of the substrate 406. The mirror coating 410 is positioned to reflect the green laser 404 which has a small beam width and thus a small spot size. Thus, the mirror coating 410 may be relatively small which allows the light from the green LED 402 to be incident on the light combiner 104 without being significantly reflected by the mirror coating 410. However, the light from the green laser 404 is reflected by the mirror coating 410 into the light combiner 104. As previously described, the holographic diffuser 409 may spread the light from both the LEDs and the laser to provide improved uniformity of illumination of the LCOS.

The configuration illustrated in FIG. 5C is similar to the configuration described connection with FIGS. 4A and 4B however with a different mirror configuration. A mirror coating 412 on the substrate 406 is a notch mirror coating. The notch mirror coating only reflects a narrow band of wavelengths of light. The green laser 404 outputs light of a specific wavelength. The notch mirror coating is configured to reflect a narrow spectral band that is matched to the green laser 404. The bandwidth of the green laser 404 is fully reflected by the notch mirror because the green laser 404 has a very narrow emission band. The green LED 402 has a wider emission band which is transmitted around the notch band.

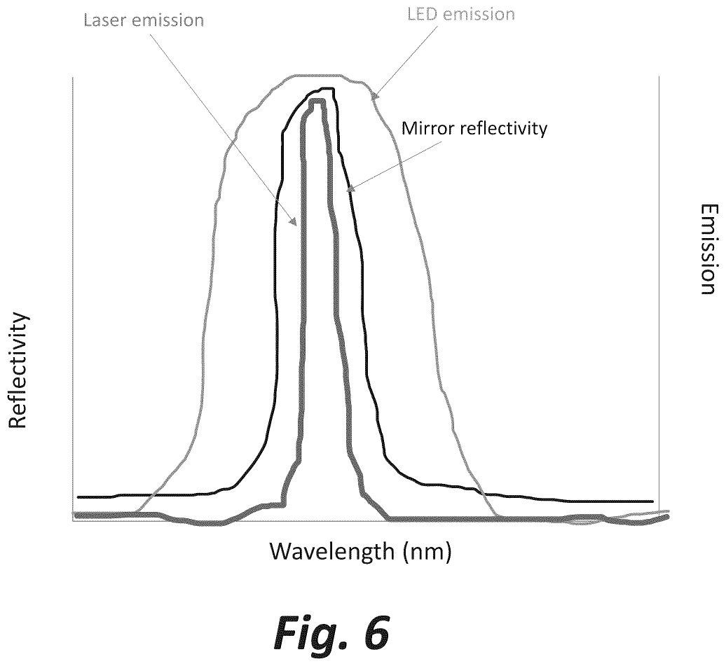

FIG. 6 is a plot which conceptually illustrates the operation of the notch mirror coating of FIG. 5C. As illustrated, the laser has a FWHM emission band that is considerably narrower than the LED. The laser's FWHM emission may be 2 nm wide. Whereas the LED may have a FWHM emission band that is 35 nm wide. The notch mirror coating can have a FWHM reflection band wide enough to reflect the laser emission band but still allow most of the LED light to pass through without reflection. In some examples, the notch mirror coating can have a FWHM reflection band or transmission band that is 8-10 nm wide.

In some embodiments, the notch mirror coating 412 may be configured to transmit a narrow band of light and reflect the rest of the light. The position of the green laser 404 and the green LED 402 may then be swapped and thus the laser light from the green laser 404 may be transmitted through the notch mirror coating 412 and the majority of the LED light from the green LED 402 may be reflected by the notch mirror coating 412.

In some examples, the mixed illumination system may be laid out in a linear layout. FIG. 5D shows an illumination system 450 with a linear layout in accordance with an embodiment of the invention. The illumination system 450 combining system including a substrate 406, a mirror coating, and a hole 408a in the mirror 408 are used to combine the light from a green laser 404 with the light from a green LED 402 along a common optical axis. The light from a red LED 102a is combined along the same optical axis by a dichroic coating 452 on an angled substrate 406, where the dichroic coating 452 is configured to transmit green light and reflect red light. Similarly, light from a blue LED 102c is combined along the same optical axis by a dichroic coating 453 on an angled substrate 406, where the dichroic coating 453 is configured to transmit green light and red light and reflects blue light. The mirror coating 408 with a hole 408a is used to combine the light from the mixed illumination source of green color and two dichroic mirrors 452, 453 are used to combine the light from two other colors to provide combined red, green and blue illumination.

A uniformizer 451 combines the red, green, and blue light into white light 106. The uniformizer 451 may be a holographic flattop diffuser. The uniformizer 451 may be a fly's eye array which mixes the red, green and blue light to provide substantially uniform illumination is a square or rectangular pattern. An example of a fly's eye array is manufactured by Edmund Optics. The fly's eye array may include a 300 μm pitch and a 13 degrees divergence.

While the implementations of FIGS. 5A-5D and 6 have been described with respect to a green light source including a green laser light source and a green LED light source to provide a green mixed illumination source, it is understood that the invention may be utilized with other colors or wavelength light sources. For example, a red mixed illumination source may include a red laser light source and a red LED light source. Also, a blue mixed illumination source may include a blue laser light source and a blue LED light source. The specific color of mixed illumination source may be based on the relative brightness of the different color light sources and the desired color matching or white balance of the combined illumination. In some embodiments, it may be advantageous to provide mixed illumination sources for more than one color channel, such as using mixed illumination for both the red and blue channels and using an LED for the green channel. Further, while the invention has been described with the different light source being a laser light source and an LED light source, it is understood that the different types of light sources may be different. For example, the light source may be a laser light source and an incandescent light source.

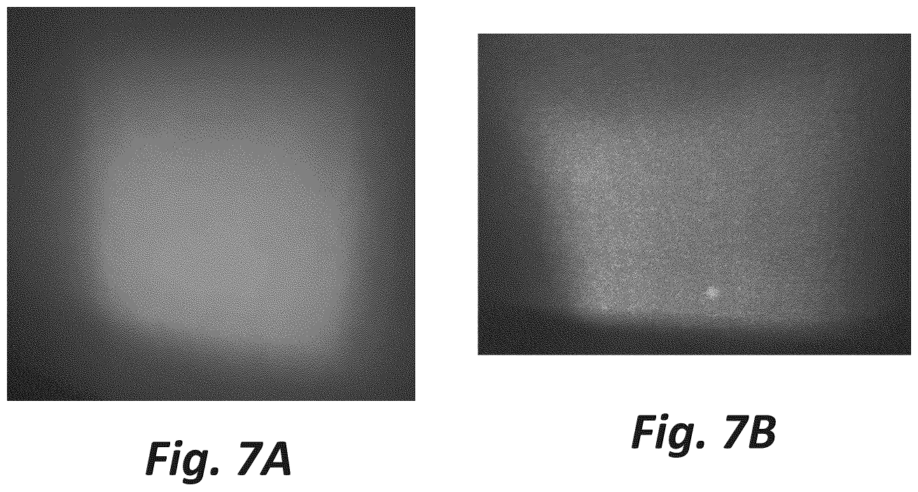

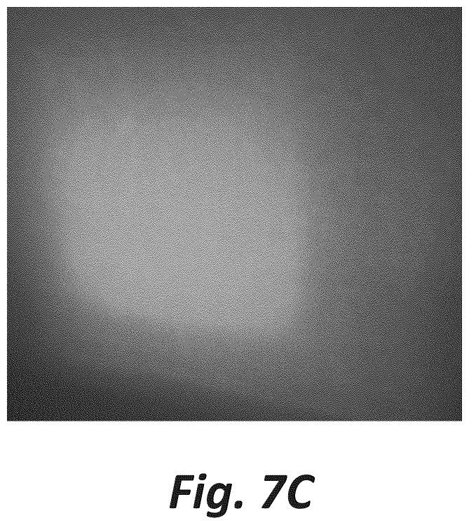

As discussed previously, a mixed illumination system may reduce speckling which may be present with solely laser sources. For example, when one of the light sources is an LED light source and the other is a laser light source, the LED light source may reduce the speckling of the laser light source. Speckling may be defined as a periodic pattern of dark and light portions of the light beam. FIG. 7A is an image of the output of a red LED light source after passing through a holographic diffuser. As illustrated, the output light from the red LED light source is fairly uniform with limited speckle. FIG. 7B is an image of the output of a green laser light source after passing through a holographic diffuser. As illustrated, the output from the green laser light source is speckled with many bright spots and dull spots. Speckle such as this is generally considered to be undesirable to a viewer of the displayed image.

FIG. 7C is an image of the output from a combined illumination source utilizing the red LED light source of FIG. 7A and the green laser light source of FIG. 7B. As illustrated, the combined illumination is a mixed color of high brightness. The mixed color has reduced speckling when compared to the output of the green laser light source alone. Thus, the mixed illumination source has reduced the effect of speckling which would be present with only a laser light source.

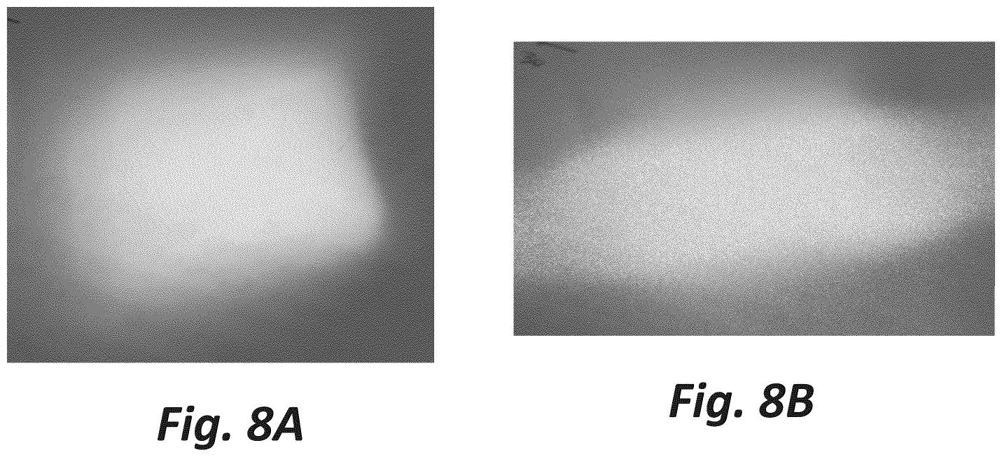

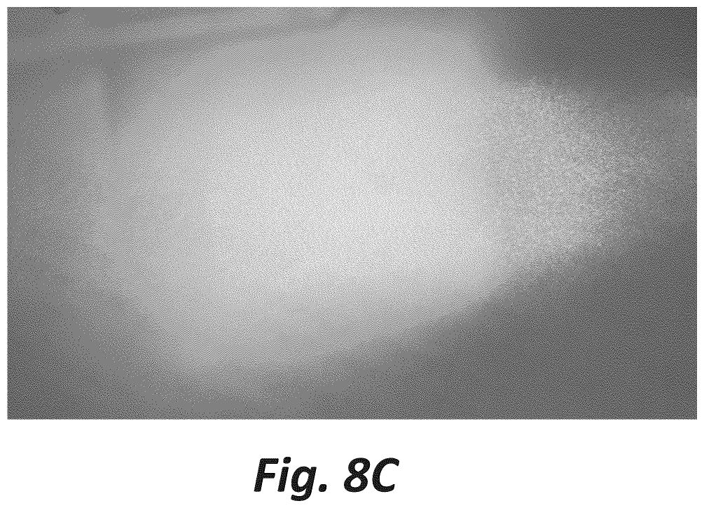

As discussed previously, the mixed illumination source may include separate types of illumination of a single color. FIG. 8A is an image of the output of a green LED light source. The output light from the green LED light source is fairly uniform without noticeable speckling. FIG. 8B is an image of the output of a green laser light source. The output from the green laser light source has noticeable speckling which causes non-uniformity. FIG. 8C is an image of the combined output of the green LED light source and the green laser light source. As illustrated, the combined output has increased brightness with greatly reduced speckling when compared to the output of the green laser light source. In some embodiments, when increased brightness is not required, the brightness of the laser light source can be reduced to further reduce speckle.

As discussed above, the holographic diffuser 409 may effectively spread the light from an original small spot to a substantially uniform illumination over a rectangular area. FIG. 9A illustrates the illumination spots in angular space produced by an example laser without a diffuser. FIG. 9B illustrates an example illumination including a holographic diffuser. The holographic diffuser may be a 35λ45° flattop holographic diffuser. The holographic diffuser may be manufactured by Luminit Co. in Torrance, CA. The holographic diffuser effectively spreads the light from the original small spot to a substantially uniform illumination over a rectangular area. However, obvious speckle still remains.

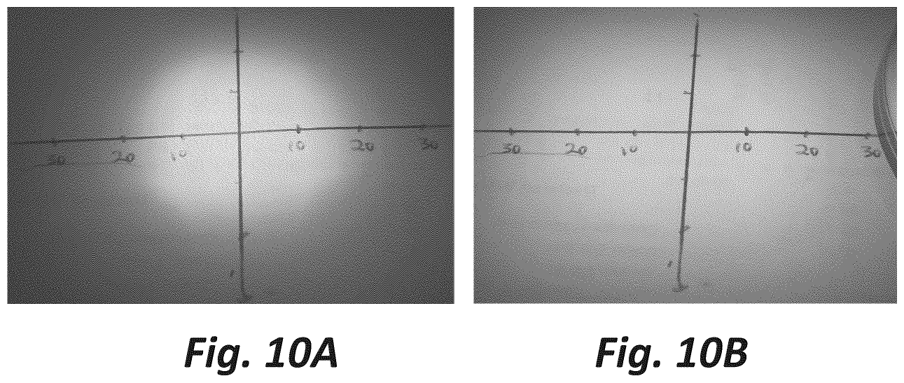

FIG. 10A shows the illumination spots in angular space produced by an example LED with a microlens without a diffuser. FIG. 10B illustrates the illumination spots including a holographic diffuser. The holographic diffuser effectively spreads the light substantially uniformly over an elliptical area that encompasses the rectangular area produced by the laser after passing through the holographic diffuser as shown in FIG. 8B.

The holographic diffuser may be designed to work with the very narrow angular emission of a laser to produce a rectangular illumination spot, so that the illumination spot as shown in FIGS. 9A and 9B, produced with the wider angular emission of the LED with microlens is somewhat rounded or elliptical as shown in FIGS. 10A and 10B. However, as illustrated, limited speckle is seen in the illumination spot produced by the LED with microlens after passing through the holographic diffuser as shown in FIG. 10B.

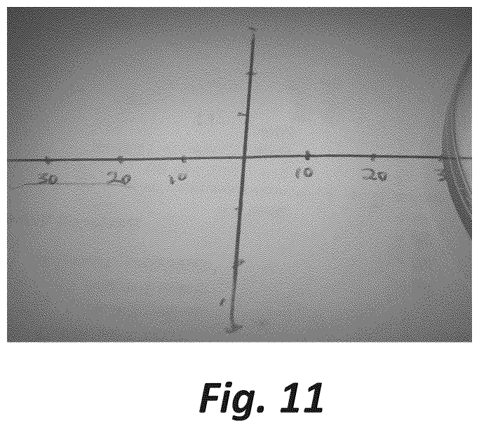

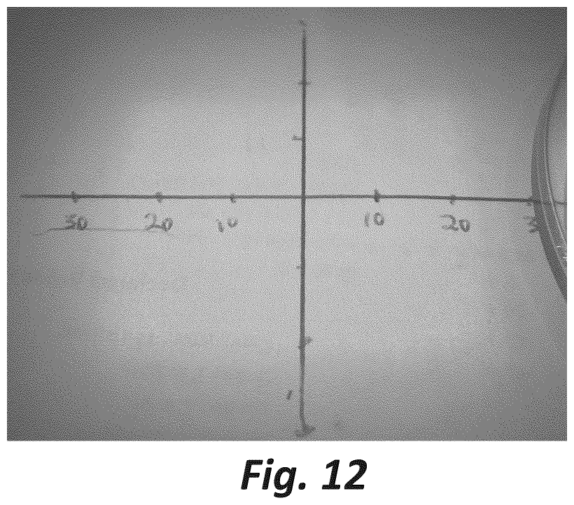

FIG. 11 shows the illumination spot in angle space produced by an LED with a microlens and a holographic diffuser. A 2 mm diameter opaque blocker has been positioned on the holographic diffuser to simulate the mirror with a hole described above in connection with FIG. 5A. The illumination spot with the holographic diffuser and blocker shown in FIG. 11 is substantially identical to that shown in FIG. 10B. Without limitation to any particular theory, this may be due to the fact that the holographic diffuser spreads all the light rays equally over the area and, as a result, blocks some of the rays which decreases the brightness of the illumination spot slightly. However, the uniformity and pattern remain largely unchanged. FIG. 12 illustrates a combined illumination spot in angular space where illumination is provided by a combined light source including a laser through the holographic diffuser and an LED with microlens through the holographic diffuser. As illustrated, this combined illumination provides increased brightness with superior uniformity and decreased speckle when compared to the illumination of FIG. 9B. These results are merely illustrative and are not limiting. In some embodiments, the holographic diffuser may be improved to make the illumination spots produced by the laser (as illustrated in FIG. 9B) and the LED with microlens (FIG. 10B) similar and thereby achieve better uniformity in the combined illumination spot when compared to the combined illumination illustrated in FIG. 12.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A mixed illumination system for a projector comprising:
a first light source;
a second light source of different type than the first light source, wherein the wavelength of an output from the second light source does not overlap with the wavelength of an output of the first light source; and
a combiner which is configured to combine the output of the first light source and the second light source, wherein light from the first light source and the second light source are combined within the combiner into a combined beam.

2. The illumination system of claim 1, wherein the first light source is a laser light source and the second light source is an LED light source, wherein the output of the laser light source has a higher speckling than the combined beam.

3. The illumination system of claim 2, further comprising a holographic diffuser.

4. The illumination system of claim 3, wherein the combined beam has a larger angular emission than the output from the first light source or the second light source.

5. The illumination system of claim 3, further comprising an angled mirror, wherein a center spot of the mirror is substantially transmissive and the surrounding area of the mirror is substantially reflective.

6. The illumination system of claim 5, further comprising a third light source with an overlapping wavelength with the laser light source, wherein the third light source is an LED light source, wherein the output from the laser light source is transmitted through the center spot and the output from the third light source is reflected by the angled reflective mirror such that the transmitted laser light and the reflected light from the third light source share a common optical axis.

7. The illumination system of claim 6, wherein the combiner is an angled mirror with a dichroic coating associated with the second light source which reflects light from the second light source and transmits light from the first light source and the third light source to transmit a combined light of the first light source, the second light source, and the third light source to provide a combined light with a common optical axis.

8. The illumination system of claim 7, further comprising a fourth light source and a second angled mirror with a dichroic coating associated with the fourth light source which reflects light from the fourth light source and transmits light form the first light source, the second light source, and the third light source to provide a combined light with a common optical axis.

9. The illumination system of claim 8, further comprising an uniformizer positioned along the common optical axis.

10. The illumination system of claim 9, wherein the uniformizer comprises a holographic flattop diffuser or a fly's eye array.

11. The illumination system of claim 6, wherein the first light source and the third light source output green light.

12. The illumination system of claim 11, wherein the first light source is a green LED light source and the third light source is a green laser light source.

13. The illumination system of claim 3, further comprising an angled mirror, wherein a center spot of the mirror is substantially reflective and the surrounding area of the mirror is substantially transmissive.

14. The illumination system of claim 13, further comprising a third light source with an overlapping wavelength with the laser light source, wherein the third light source is an LED light source, wherein the output from the laser light source is transmitted through the center spot and the output from the third light source is reflected by the angled reflective mirror such that the transmitted laser light and the reflected light from the third light source share a common optical axis.

15. The illumination system of claim 14, wherein the combiner is an angled mirror with a dichroic coating associated with the second light source which reflects light from the second light source and transmits light from the first light source and the third light source to transmit a combined light of the first light source, the second light source, and the third light source to provide a combined light with a common optical axis.

16. The illumination system of claim 15, further comprising a fourth light source and a second angled mirror with a dichroic coating associated with the fourth light source which reflects light from the fourth light source and transmits light form the first light source, the second light source, and the third light source to provide a combined light with a common optical axis.

17. The illumination system of claim 16, further comprising a uniformizer positioned along the common optical axis.

18. The illumination system of claim 17, wherein the uniformizer comprises a holographic flattop diffuser or a fly's eye array.

19. The illumination system of claim 3, further comprising an angled mirror, wherein the mirror is a notch mirror with a narrow band of reflectivity and the output from the laser light source has an emission band falling within the narrow band of reflectivity.

20. The illumination system of claim 19, wherein the output from the laser light source is reflected by the angled mirror and the output from the LED light source has an emission band substantially wider than the narrow band of reflectivity such that the laser light is reflected by the mirror and a majority of the LED light is transmitted through the mirror, and wherein the reflected laser light and the transmitted LED light share a common optical axis.
